(19) United States
(12) Patent Application Publication
(10) Pub. No.: US 2009/0050116 A1
(43) Pub. Date: Feb. 26, 2009

(54) FLUID IONIZING DEVICE FOR INTERNAL COMBUSTION ENGINES

(76) Inventor: Craig D. Cummings, Park City, UT (US)

Correspondence Address: BROOKS KUSHMAN P.C., 1000 TOWN CENTER, TWENTY-SECOND FLOOR, SOUTHFIELD, MI, 48075, US

(21) Appl. No.: 11/842,423

(22) Filed: Aug. 21, 2007

(51) Int. Cl. F02M 27/00

(52) U.S. Cl. 123/538

(57) ABSTRACT

A fluid ionizing device for use in an inlet air passage of an internal combustion diesel engine provides for improving combustion in the engine and reducing soot in the exhaust manifold of the engine.

### BACKGROUND OF THE INVENTION

1. Field of the Invention

The present invention relates to improving combustion in an internal combustion engine, and more particularly to improving combustion in a diesel engine.

2. Background Art

The principles of operation of internal combustion engines are well understood. Air and fuel are mixed and drawn into a combustion chamber through inlet valves, where they are ignited. Combustion of an air-fuel mixture releases chemical energy creating high temperature, high pressure combustion products which are expanded within the engine to power the rotating output shaft to engine components, allowing the engine to do work. The combustion process is often inefficient, producing exhaust gases having undesired pollutants and other waste elements, such as soot and smoke. This is especially true with regard to diesel engines when operated at high load.

Diesel particulate filters (DPF) are becoming increasingly common in vehicles with diesel engines. DPFs are located in the engine exhaust stream to remove undesired particulates, such as soot, from the exhaust gas. In addition to collecting the particulates, a method must exist to clean the filter. Some filters are removable and can be cleaned, while others are designed to automatically burn off the accumulated particulates. However, these methods can be inconvenient and costly for a vehicle operator. Therefore, there is a need to improve the engine combustion process to more completely burn fuel in order to minimize soot production and to convert more of the fuel's chemical energy into useful work.

### SUMMARY OF THE INVENTION

A variation of the present invention provides a fluid ionizing device for use in an inlet air passage of an internal combustion engine, the device comprising a tubular housing having an inlet configured to receive an inlet flow of air, an outlet, and a body extending axially between the inlet and the outlet, the housing defining a cavity therein. A plurality of inwardly extending spaced apart electrode pairs are disposed circumferentially about the body of the housing, each electrode having a conductive end at least partially exposed within the cavity of the housing, wherein each electrode pair is adapted to produce an electrical discharge therebetween. A controller is in electrical communication with each electrode pair, the controller configured to enable an electrical discharge associated with one or more electrode pairs at a frequency based at least in part on a signal from an engine sensor. Preferably the electrodes of said fluid ionizing device being axially spaced apart.

Another variation of the present invention provides an internal combustion engine system comprising an internal combustion engine, having one or more sensors and an intake manifold for receiving air, a fluid ionizing device, and an engine control unit. The fluid ionizing device comprises a tubular housing having an inlet configured to receive an inlet flow of air, an outlet, and a body extending axially between the inlet and the outlet, the housing defining a cavity therein. With respect to the fluid ionizing device, a plurality of inwardly extending spaced apart electrode pairs are disposed circumferentially about the body of the housing, each electrode having a conductive end at least partially exposed within the cavity of the housing, wherein each electrode pair is adapted to produce an electrical discharge therebetween. The fluid ionizing devices also includes a controller in electrical communication with each electrode pair, the controller configured to enable an electrical discharge associated with one or more electrode pairs at a frequency based at least in part on a signal from one or more of the sensors associated with the internal combustion engine. Optionally, an engine control unit is in electrical communication with the fluid ionizing device controller, the engine control unit having one or more outputs which can be used by the device controller to vary the ionizer output.

Yet another variation of the present invention provides an internal combustion diesel engine system comprising an internal combustion diesel engine, having one or more sensors and an intake manifold for receiving air, a fluid ionizing device, and an engine control unit having one or more outputs. The fluid ionizing device comprises a tubular housing having an inlet configured to receive an inlet flow of air, an outlet, and a body extending axially between the inlet and the outlet, the housing defining a cavity therein. The fluid ionizing device further comprises a plurality of inwardly extending axially aligned spaced apart electrode pairs disposed circumferentially about the body of the housing, each electrode having a conductive end at least partially exposed within the cavity of the housing, wherein each electrode pair is adapted to produce an electrical discharge therebetween. The fluid ionizing device further comprises a controller in electrical communication with each electrode pair, the controller configured to enable an electrical discharge associated with one or more electrode pairs at a frequency based at least in part on a signal from one or more of the sensors associated with the internal combustion engine. Optionally, the engine control unit is in electrical communication with the fluid ionizing device controller via a power transformer, the transformer adaptable to electrically isolate the fluid ionizing device controller from the engine control unit.

Another variation of the present invention provides a method for reducing soot in an internal combustion engine exhaust manifold, the method comprising providing an intake manifold of an internal combustion engine, having one or more sensors, with a fluid ionizing device. The fluid ionizing device comprises a tubular housing having an inlet configured to receive an inlet flow of air, an outlet in fluid communication with the intake manifold, and a body extending axially between the inlet and the outlet, the housing defining a cavity therein. The ionizing device further comprises a plurality of inwardly extending spaced apart electrode pairs disposed circumferentially about the body of the housing, each electrode having a conductive end at least partially exposed within the cavity of the housing, wherein each electrode pair is adapted to produce an electrical discharge therebetween. The ionizing device further comprises a controller in electrical communication with each electrode pair, the controller configured to enable an electrical discharge associated with one or more electrode pairs at a frequency based at least in part on a signal from one or more sensors associated with the internal combustion engine. Optionally, the method further comprises providing an engine control unit in electrical communication with the fluid ionizing device controller, the engine control unit having one or more outputs. The method further comprises varying the frequency of the fluid ionizing device controller as a function of the one or more engine control unit outputs.

### BRIEF DESCRIPTION OF THE DRAWINGS

FIG. 1 shows a convention internal combustion engine system.

FIG. 2A shows an internal combustion engine system in accordance with an embodiment of the present invention, wherein the engine system includes a supercharger.

FIG. 2B shows an internal combustion engine system in accordance with an embodiment of the present invention, wherein the engine system includes a turbocharger.

FIG. 3A shows a fluid ionizing device in accordance with embodiments of the present invention.

FIG. 3B shows a cross-sectional view of the fluid ionizing device of FIG. 3A along line 3-3.

FIG. 4A shows another fluid ionizing device in accordance with embodiments of the present invention.

FIG. 4B shows a cross-sectional view of the fluid ionizing device of FIG. 4A along line 3-3.

FIG. 5 shows a fluid ionizing device controller in accordance with embodiments of the present invention.

### DETAILED DESCRIPTION OF THE PREFERRED EMBODIMENT(S)

Reference will now be made in detail to presently preferred compositions, embodiments and methods of the present invention, which constitute the best modes of practicing the invention presently known to the inventors. The Figures are not necessarily to scale. However, it is to be understood that the disclosed embodiments are merely exemplary of the invention that may be embodied in various and alternative forms. Therefore, specific details disclosed herein are not to be interpreted as limiting, but merely as a representative basis for any aspect of the invention and/or as a representative basis for teaching one skilled in the art to variously employ the present invention.

Except in the examples, or where otherwise expressly indicated, all numerical quantities in this description indicating amounts of material or conditions of reaction and/or use are to be understood as modified by the word “about” in describing the broadest scope of the invention.

It is also to be understood that this invention is not limited to the specific embodiments and methods described below, as specific components and/or conditions may, of course, vary. Furthermore, the terminology used herein is used only for the purpose of describing particular embodiments of the present invention and is not intended to be limiting in any way.

It must also be noted that, as used in the specification and the appended claims, the singular form “a”, “an”, and “the” comprise plural referents unless the context clearly indicates otherwise. For example, reference to a component in the singular is intended to comprise a plurality of components.

Throughout this application, where publications are referenced, the disclosures of these publications in their entireties are hereby incorporated by reference into this application to more fully describe the state of the art to which this invention pertains.

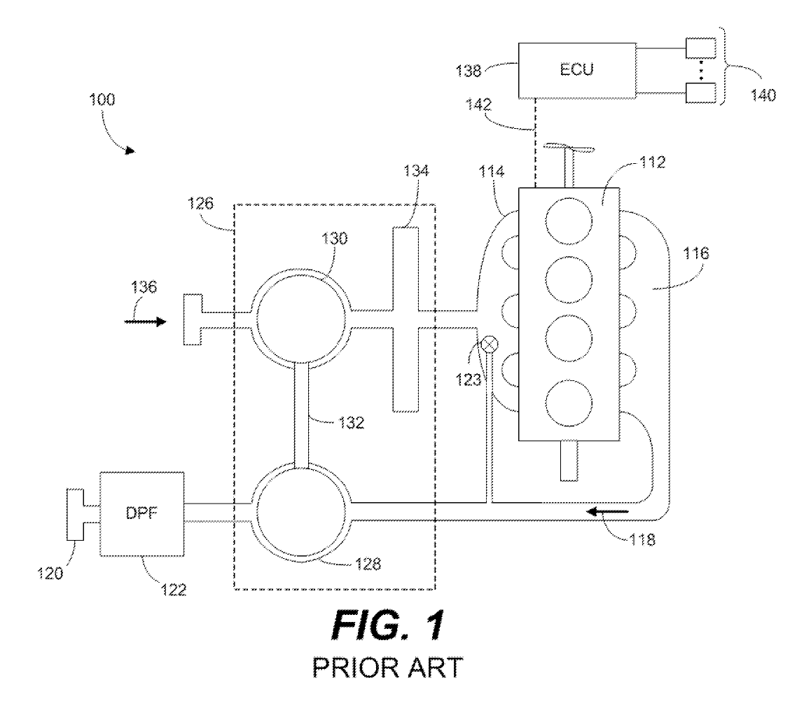

FIG. 1 shows an internal combustion engine system 100 in which embodiments of the present invention may be installed. The system 100 includes an internal combustion diesel engine 112 having an intake manifold 114, for receiving air, and an exhaust manifold 116, for releasing combusted gases 118 via exhaust pipe 120. Although the engine 112 is shown as a four-cylinder engine, an engine of any suitable size having any number of cylinders may be used in accordance with embodiments of the present invention. The combusted gases 118 may be any gases resulting from combustion within the combustion chambers of the engine 112. The system 100 can include a diesel particulate filter (DPF) 122 for reducing soot emissions. The system 100 may also include an exhaust gas recirculation (EGR) valve 124 for recirculating some of the engine's combusted gases 118 to the intake manifold 114 to control NOₓ emissions. As will be apparent from the following disclosure, embodiments of the present invention provide for an improved combustion process, resulting in fewer undesirable pollutants in the combusted gases 118, thereby increasing the longevity of the pollution abatement devices, such as the diesel particulate filter 122 and improving fuel efficiency.

With continued reference to FIG. 1, the system 100 may include a turbocharger 126 for improving the power output of the engine 112. Turbochargers are conventionally exhaust gas driven forced induction devices used to improve engine performance by forcing compressed air into the combustion chambers of the engine 112, allowing more fuel to be burned, resulting in a larger power output. As conventionally shown, the turbocharger 126 includes a turbine 128 and a compressor 130 linked by a shared axle 132, and an optional intercooler 134. The turbine 128 receives combusted gases 118 from the engine exhaust manifold 116 causing the turbine wheel (not shown) to rotate. This rotation drives the compressor 130, compressing ambient air 136 and delivering the air 136 to the intake manifold 114 of the engine 112 via the intercooler 134, if such an intercooler is present.

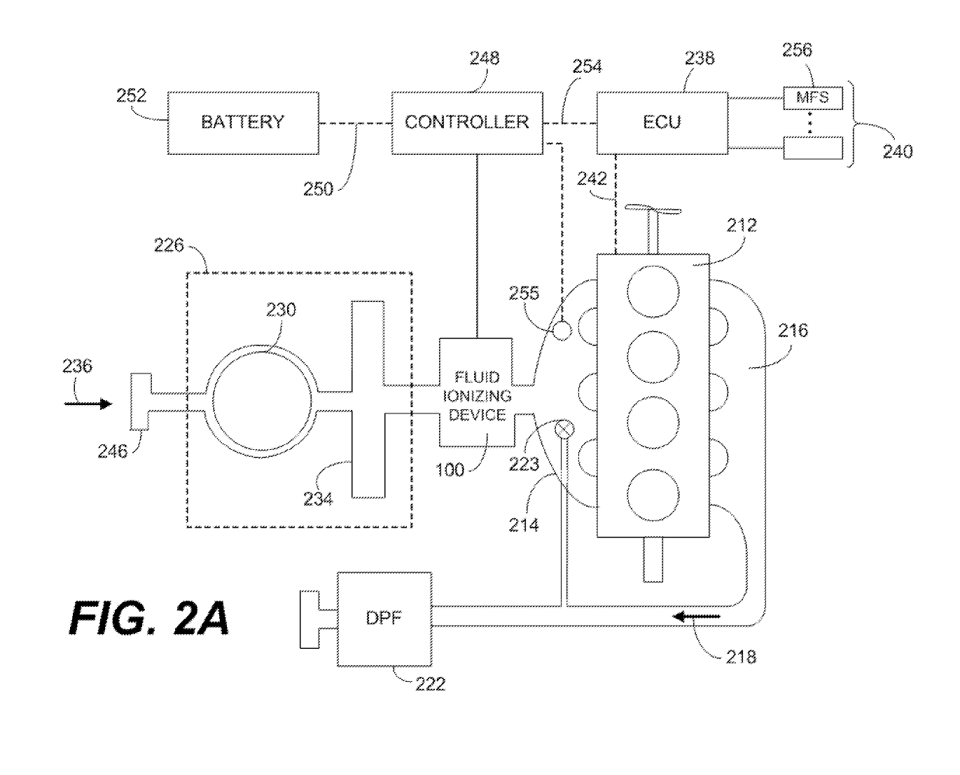

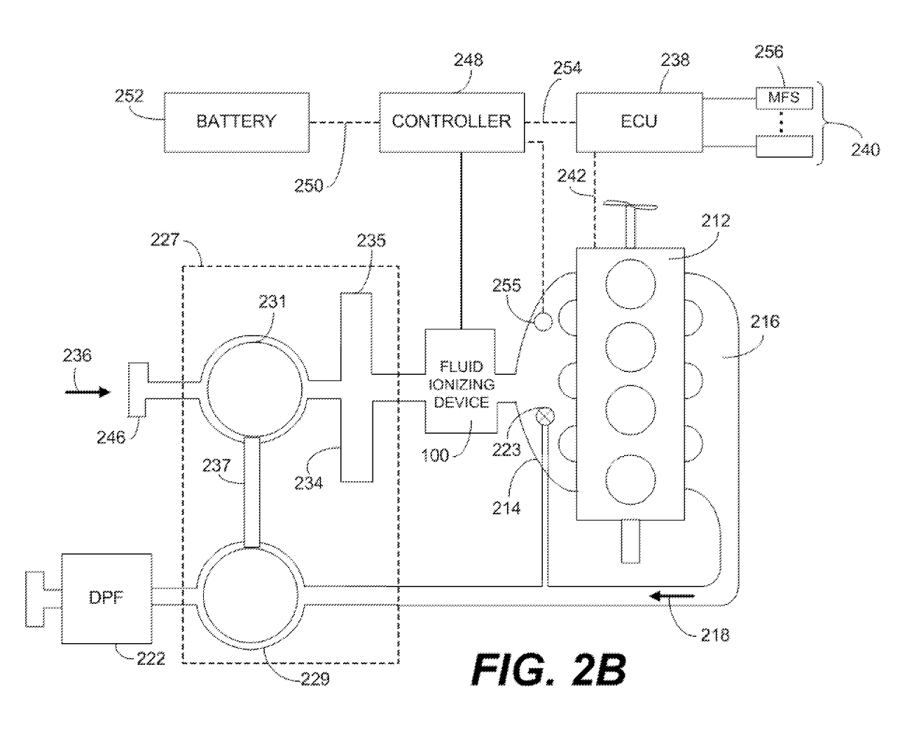

Although not shown, the system 100 may include a supercharger instead of, or in addition to, the turbocharger 126. Superchargers are mechanical air compressors driven by a power take-off or an electric motor used to provide more air into the combustion chamber(s) of an engine and achieving similar results to that of the turbocharger. An intercooler may be interposed between the supercharger compressor and intake manifold 114 to reduce the temperature of the air. Such a supercharger and optional intercooler are illustrated in the system 200 of FIG. 2A. Depending on the size of the configuration of the engine 114, multiple superchargers and/or turbochargers may be used in the system 100 in any suitable configuration.

Still referring to FIG. 1, the system 100 is provided with an engine control unit (ECU) 138 for controlling various aspects of the engine 112 such as fuel injection time and quantity. The ECU 138 receives inputs from one or more sensors 140 to control, in part, various aspects of the engine 112 by providing output signals 142 as a function of signals received from the respective sensors 140. For example, the ECU 138 may control aspects of the vehicle such as the ignition timing, variable valve timing, the level of boost maintained by the turbocharger 126 (or supercharger), and the like. ECU inputs may include a load input (accelerator) from the operator, intake manifold pressure and temperature, engine speed, barometric pressure, etc.

Referring to FIGS. 2A and 2B, an engine system 200 and 200′ is shown in accordance with an embodiment of the present invention, in which an engine 212, having an intake manifold 214 and an exhaust manifold 216, is provided with a fluid ionizing device 210 disposed at the inlet of the intake manifold 214. The ionizing device 244 receives air via the turbine 234 of a supercharger 226 as shown. Of course, the system is easily adaptable such that the ionizing device 244 instead receives ambient air 236 from the intercooler of a turbocharger, as shown in an embodiment of the invention in FIG. 2B, or from the air inlet 246. The electrodes of the ionizing device 244 may be in electrical communication with a controller 248, which controls various functions of the ionizing device 244, such as firing frequency, firing sequence, and the like. The controller 248 is powered by the vehicle battery 252, as depicted by element 250. The voltage delivered to the controller 248 by the battery 252 may be increased or decreased in any suitable manner. The controller 248 communicates with the ECU 238 to receive control signals outputted by the ECU 238 as a function of one or more inputs to the ECU, for example via engine sensors 240.

With continued reference to FIGS. 2A and 2B, the ECU 238 could, for example, send control signals 254 to the controller 248 as a function of an intake manifold pressure sensor 256 output, in which the control signals 254, in part, dictates the firing frequency of the controller 248. Accordingly, as the intake manifold pressure increases, the ECU 238 receives varied signals from the manifold pressure sensor 256 and, in turn, sends control signals 254 to the controller 248 conveying a change in firing frequency. Providing feedback to the controller 248 from the ECU 238 in such a manner allows the controller 248 to dictate the controller firing frequency, among other parameters, and allow for a variable electrode firing rate. Controlling the controller firing rate, as previously mentioned, can provide an optimized proportion of ionized air to the engine 212 via the intake manifold 214, resulting in an improved combustion process. Of course the control input need not receive the control signal 254 from the ECU 238. Instead, the control input could be received from a dedicated sensor, such as n intake manifold pressure sensor 255, enabling the ionizing device 244 to function with a pre-determined firing frequency.

FIGS. 2A and 2B further show a method in accordance with embodiments of the present invention for reducing soot in the exhaust manifold 216 of the engine 212. The intake manifold 214 of the internal combustion engine 214 is provided with the fluid ionizing device 224, in which the engine 212 includes one or more sensors 240 providing input signals to the ECU 238. The ECU 238, in turn, provides one or more control signals 254 to the ionizing device controller 248 and varies the firing frequency, among other parameters, as a function of the one or more control signals 254.

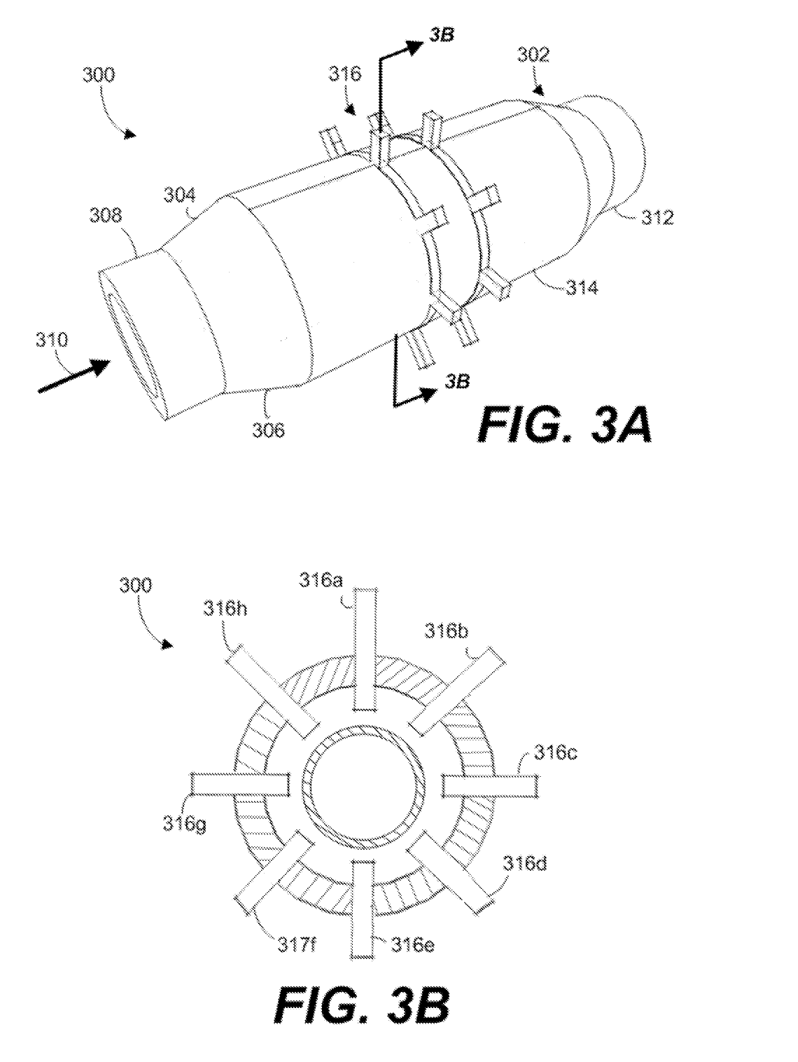

With reference to FIG. 3, a fluid ionizing device 300 in accordance with an embodiment of the invention is shown. The housing 302 may be formed from a first portion 304 and a second portion 306 adjoined to one another. The portions 304,306 may be adjoined in any suitable manner. One non-limiting aspect of the ionizing device 300 contemplates adjoining the first and second housing portions 304, 306 in a clam shell configuration defining a cavity therewithin, such that the portions 304,306 may be adjoined via a fastener or an adhesive, or via any other suitable method known in the art. With respect to said clam shell configuration, a number of suitable methods may be used to form portions 304, 306. For example, the portions 304, 306 may be injection molded from a non conductive high temperature plastic and adjoined as previously described. Another non-limiting aspect of the ionizing device 300 contemplates the housing 302 being formed from a single portion defining a cavity therewithin. With respect to this configuration, any suitable method may be used to form the single portion, for example via blow molding or rotomolding a non conductive polymer.

As shown in FIG. 3, the two portions 304,306, when adjoined, form a generally tubular housing having an inlet 308 configured to receive an inlet flow of air 310, an outlet 312, and a body 314 extending axially between the inlet 308 and the outlet 312. The body portion 314 is configured with eight axially aligned electrode pairs, generally indicated by 316, disposed circumferentially about the periphery of the body 314. In practice, any number of electrode pairs may be used as dictated by the size and relative geometry of the ionizing device 300. An embodiment of the invention contemplates using automotive spark plugs as electrodes, as they are easily adaptable and widely available for use. However, any suitable electrode may be used in place of, or in addition to, the spark plugs; the choice of electrode is not meant to limit in the scope of the present invention. As shown, each electrode 316 is disposed about the outer periphery of the ionizing device body 314 such that each electrode 316 extends radially inward through the body 314 having a conductive end partially exposed within the cavity of the housing. Each electrode pair 316 includes an anode and a cathode, as indicated by the “+” and “−” symbols respectively.

Still referring to FIG. 3, the electrode pairs 316 are adaptable to produce an electrical discharge between the electrode tips upon a sufficiently large voltage differential between the tips. Such an electrical discharge can ionize an otherwise neutral gas in the proximity of an electrode pair 316. In a variation of the present invention, the otherwise neutral gas is air. Ionization of air results in a number of energetic chemical species that enhance combustion of the fuel. In one refinement, the generated chemical species include ozone, hydroxyl radical, molecular oxygen in excited electronic vibrational and/or rotational states, oxygen radicals, ionized molecular oxygen, peroxide radical (e.g., hydrogen peroxide radical), molecular nitrogen in excited electronic, vibrational and/or rotational states, oxides of nitrogen (NO, NO₂ and the like), and combinations thereof. Reactive chemical species that are useful in general are stable enough to survive until mixing with fuel. In a refinement, the generated chemical species include ozone, hydroxyl radical, oxide of nitrogen, and combinations thereof. The amount of generates chemical species ranges from about 10 ppm to about 3 weight percent based on the on the initial amount of unionized air. In another refinement of the present invention, the amount of generates chemical species ranges from about 50 ppm to about 1 weight percent based on the on the initial amount of unionized air. In another refinement of the present invention, the amount of generates chemical species ranges from about 100 ppm to about 0.5 weight percent based on the initial amount of unionized air.

Parameters relating to each electrode pair 316, such as the firing sequence and timing, may be controlled in a number of ways. Controlling these parameters can provide a number of benefits. For example, controlling the firing frequency of one or more electrode pairs 316 allows for directly controlling the rate of gas ionization, thereby advantageously providing a firing frequency dependent concentration of ionized gas via the outlet 312 of the fluid ionizing device 300. Alternatively, controlling a subset of electrode pairs (e.g. alternate pairs) while precluding the operation of the other pairs may allow for a similar result. An embodiment of the ionizing device 300 contemplates controlling various parameters relating to each electrode pairs, such as the firing sequence, timing, and the like, via a controller electrically connected to each electrode pair 316. Various aspects of said controller are described in the following disclosure.

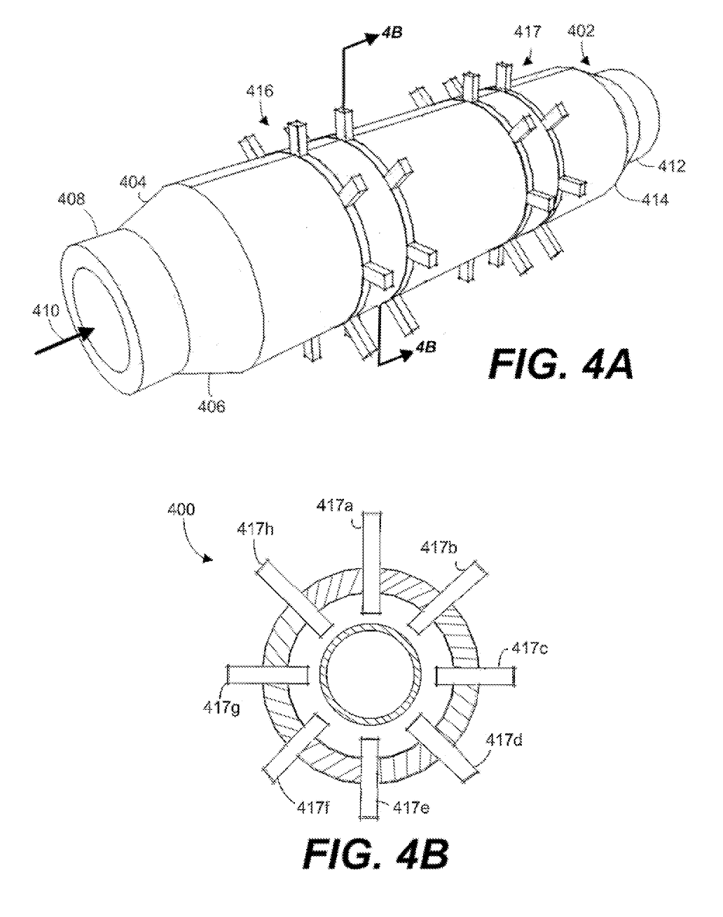

FIG. 4 shows a variation of the fluid ionizing device 300 shown in FIG. 3. The ionizing device 400 includes a second plurality of eight axially aligned electrode pairs disposed circumferentially about the periphery of the body 414. Each electrode 417 extends radially inward through the body 414 having a conductive end partially exposed within the cavity of the housing.

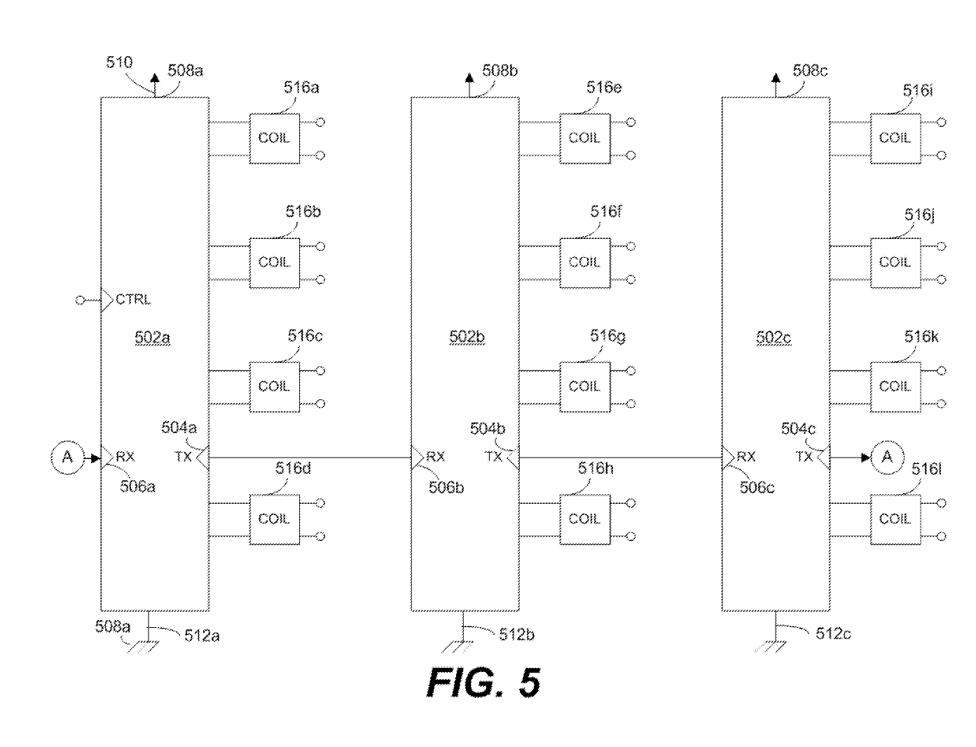

FIG. 5 shows a diagram of a controller which, in accordance with embodiments of the present invention, allows for controlling the firing sequence, timing, and various other aspects of electrode pairs in a fluid ionizing device. The controller 500 includes several sub-controller modules, generally indicated by 502, that communicate with one another via transmit 504 and receive 506 signal lines, labeled “TX” and “RX” respectively. As shown, each module 502 is powered at the terminal 508 labeled “B+” by the vehicle battery positive output 510 and grounded at the terminal 512 labeled “GROUND” via the vehicle battery ground 514. Although the battery positive output 510 is shown to be directly connected to the power terminal 508 of each module 502, any suitable mechanism may be used to reduce or increase the voltage to accommodate the power requirement of each module 502. For example, a voltage regulator circuit could be interposed between positive the positive battery terminal 510 and the module power terminal 508 to step down the battery voltage. One skilled in the art will recognize a variety of other suitable means for interfacing the modules 502 with a power supply.

With continuing reference to FIG. 5, each module 502 provides output signals to four pairs of coils. Each coil pair is generally indicated by 516. One skilled in the art will recognize that the modules 502 can be easily adapted to accommodate a different number of coil pairs 516. For example, modules 502 could be in a daisy-chained or multiplexed configuration with additional modules to accommodate a greater number of electrodes corresponding to a given controller. Of course, the modules 502 can also be easily be adapted to accommodate a fewer number of electrodes. Sub-module 502a is provided with a control input 518 for, among other things, initiating or terminating an electrode firing sequence. Although control input 518 is shown as a single input for diagrammatic simplicity, module 502a can easily be adapted to accommodate a greater number of inputs as dictated by the particular application. For example, control input 518 may include three inputs, in which a first input acts as a “trigger mechanism” for activating a module, a second input allows for varying the frequency of a module, and a third input allows for selecting which outputs to enable or disable.

As an example, assume for simplicity, that the control input 518 provides module 502a with an “on-off” input, wherein the “on” state initiates a firing sequence of module 502a with a pre-determined frequency, and the “off” state ends the firing sequence. When module 502a is first initialized via the control input 518, module 502a cycles through each output signal pair, enabling each corresponding coil pair 516. After cycling through each coil pair 516a, 516b, 516c, and 516d, module 502a sends an enabling signal, via transmit port 504a, to receive port 512b of module 502b. In a similar fashion, module 502b cycles through each output pair, enabling each corresponding coil pair, and enables the following sub-module 502c. This process cyclically continues for each module 502 until an “off” state control input 518 is received by module 502a. In this manner, each coil pair 516 in each module 502 is enabled at least once, granted that the coil pair 516 is not obviated by another function of control input 518.

Of course module 502a can easily be modified to allow the control input 518 to provide different or additional functions. For example, through one modification, the control input 518 could initialize the module output sequence and additionally vary the frequency of the output sequence. In another scenario, the control input 518 could disable one or more outputs for a given module 502. In yet another scenario, the control input 518 could dictate whether each of the outputs is enabled in a cycling fashion or simultaneously. The control input 518 may be provided via a Controller Area Network (CAN) bus, such that the controller 500 is able to interact with various sensors and other entities throughout a vehicle. One skilled in the art will recognize that the controller is adaptable to a number of configurations as dictated by the particular application.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A fluid ionizing device for use in an inlet air passage of an internal combustion engine, the device comprising:
a tubular housing having an inlet configured to receive an inlet flow of air, an outlet, and a body extending axially between the inlet and the outlet, the housing defining a cavity therein;
a plurality of inwardly extending spaced apart electrode pairs disposed circumferentially about the body of the housing, each electrode having a conductive end at least partially exposed within the cavity of the housing, wherein each electrode pair is adapted to produce an electrical discharge therebetween; and
a controller in electrical communication with each electrode pair, the controller configured to enable an electrical discharge associated with one or more electrode pairs at a frequency based at least in part on a signal from an engine sensor.

2. The fluid ionizing device of claim 1, wherein at least one of the electrode pairs is axially aligned.

3. The fluid ionizing device of claim 1, wherein the sensor is an intake manifold pressure sensor.

4. The fluid ionizing device of claim 1, wherein the housing is plastic.

5. The fluid ionizing device of claim 4, wherein the housing is a clamshell housing having two adjoined portions.

6. The fluid ionizing device of claim 1, wherein the housing is configured to receive the inlet flow of fluid from a turbocharger.

7. The fluid ionizing device of claim 1, wherein the controller is in electrical communication with each electrode pair via a power transformer adaptable to electrically isolate the controller from the electrode pairs.

8. The fluid ionizing device of claim 1, wherein the controller comprises a plurality of sub-controllers in communication with one another, wherein each sub-controller is configured to enable an electrical discharge associated with at least four electrode pairs.

9. A fluid ionizing device for use in an inlet air passage of an internal combustion engine, the device comprising:
a tubular housing having an inlet configured to receive an inlet flow of air, an outlet, and a body extending axially between the inlet and the outlet, the housing defining a cavity therein;
a plurality of inwardly extending axially aligned spaced apart electrode pairs disposed circumferentially about the body of the housing, each electrode having a conductive end at least partially exposed within the cavity of the housing, wherein each electrode pair is adapted to produce an electrical discharge therebetween; and
a controller in electrical communication with each electrode pair, the controller configured to enable an electrical discharge associated with one or more electrode pairs at a frequency based at least in part on a signal from an engine sensor.

10. The fluid ionizing device of claim 9, wherein the sensor is an intake manifold pressure sensor.

11. The fluid ionizing device of claim 9, wherein the sensor is associated with an engine control unit.

12. The fluid ionizing device of claim 9, wherein the housing is plastic.

13. The fluid ionizing device of claim 12, wherein the housing is a clamshell housing having two adjoined portions.

14. The fluid ionizing device of claim 9, wherein the housing is configured to receive the inlet flow of fluid from a turbocharger.

15. The fluid ionizing device of claim 9, wherein the controller is in electrical communication with each electrode pair via a power transformer adaptable to electrically isolate the controller from the electrode pairs.

16. The fluid ionizing device of claim 9, wherein the controller comprises a plurality of sub-controllers in communication with one another, wherein each sub-controller is configured to enable an electrical discharge associated with at least four electrode pairs.

17. An internal combustion engine system comprising:
an internal combustion engine, having one or more sensors and an intake manifold for receiving air;
a fluid ionizing device comprising:
a) a tubular housing having an inlet configured to receive an inlet flow of air, an outlet, and a body extending axially between the inlet and the outlet, the housing defining a cavity therein,
b) a plurality of inwardly extending spaced apart electrode pairs disposed circumferentially about the body of the housing, each electrode having a conductive end at least partially exposed within the cavity of the housing, wherein each electrode pair is adapted to produce an electrical discharge therebetween, and
c) a controller in electrical communication with each electrode pair, the controller configured to enable an electrical discharge associated with one or more electrode pairs at a frequency based at least in part on a signal from one or more of the sensors associated with the internal combustion engine; and
an engine control unit in electrical communication with the fluid ionizing device controller, the engine control unit having one or more outputs.

18. The combustion engine system of claim 17, wherein the frequency of the fluid ionizing device controller is at least in part determined by one or more of the engine control unit outputs.

19. The combustion engine system of claim 17 further comprising an intake manifold pressure sensor, wherein the frequency of the fluid ionizing device controller is at least in part determined by an output from the pressure sensor.

20. The combustion engine system of claim 17 further comprising a turbocharger, wherein the fluid ionizing device is configured to receive the inlet flow of fluid from the turbocharger.

21. An internal combustion diesel engine system comprising:
an internal combustion diesel engine, having one or more sensors and an intake manifold for receiving air;
a fluid ionizing device comprising:
a) a tubular housing having an inlet configured to receive an inlet flow of air, an outlet, and a body extending axially between the inlet and the outlet, the housing defining a cavity therein,
b) a plurality of inwardly extending axially aligned spaced apart electrode pairs disposed circumferentially about the body of the housing, each electrode having a conductive end at least partially exposed within the cavity of the housing, wherein each electrode pair is adapted to produce an electrical discharge therebetween, and
c) a controller in electrical communication with each electrode pair, the controller configured to enable an electrical discharge associated with one or more electrode pairs at a frequency based at least in part on a signal from one or more of the sensors associated with the internal combustion engine; and
an engine control unit having one or more outputs, the engine control unit in electrical communication with the fluid ionizing device controller via a power transformer, the transformer adaptable to electrically isolate the fluid ionizing device controller from the engine control unit.

22. The combustion engine system of claim 21, wherein the frequency of the fluid ionizing device controller is determined at least in part by one or more of the sensors associated with the engine.

23. The combustion engine system of claim 21 further comprising a manifold pressure sensor, wherein the frequency of the fluid ionizing device controller is determined at least in part by an output from the manifold pressure sensor.

24. The combustion engine system of claim 21 further comprising a turbocharger having an intercooler, wherein the fluid ionizing device is configured to receive the inlet flow of fluid from the turbocharger.

25. A method for reducing soot in an internal combustion engine exhaust manifold, the method comprising:
providing an intake manifold of an internal combustion engine with a fluid ionizing device, the engine having one or more sensors, the fluid ionizing device comprising:
a) a tubular housing having an inlet configured to receive an inlet flow of air, an outlet in fluid communication with the intake manifold, and a body extending axially between the inlet and the outlet, the housing defining a cavity therein,
b) a plurality of inwardly extending spaced apart electrode pairs disposed circumferentially about the body of the housing, each electrode having a conductive end at least partially exposed within the cavity of the housing, wherein each electrode pair is adapted to produce an electrical discharge therebetween, and
c) a controller in electrical communication with each electrode pair, the controller configured to enable an electrical discharge associated with one or more electrode pairs at a frequency based at least in part on a signal from one or more sensors associated with the internal combustion engine;
providing an engine control unit in electrical communication with the fluid ionizing device controller, the engine control unit having one or more outputs; and
varying the frequency of the fluid ionizing device controller as a function of the one or more engine control unit outputs.
